(19) United States
(12) Patent Application Publication
(10) Pub. No.: US 2011/0005131 A1
(43) Pub. Date: Jan. 13, 2011

(54) Growth System for Plants

(75) Inventors: Jan J. Smits, Hoek van Holland (NL); Franciscus Johannes Ignatius van Maanen, Den Haag (NL); Leonardus Antonius Maria Brouwers, Beesel (NL)

Correspondence Address: SWANSON & BRATSCHUN, L.L.C., 8210 SOUTHPARK TERRACE, LITTLETON, CO, 80120, US

(73) Assignee: Nederlandse Organisatie voor toegepast-natuurwetenschappelijk Onderzoek TNO, Delft (NL)

(21) Appl. No.: 12/663,692

(22) PCT Filed: Jun. 11, 2008
(86) PCT No.: PCT/NL2008/050366

§ 371 Date: Jun. 9, 2010

(30) Foreign Application Priority Data
Jun. 11, 2007 (EP) 07109988.1

(51) Int. Cl. A01G 7/02; A01G 9/02

(52) U.S. Cl. 47/79

(57) ABSTRACT

Growth system for plants, comprising a tube (1) which is arranged to be inserted by plant cartridges (2) each comprising at least one plant (3) and enabling the plant roots to extend into the interior of the tube. Moreover, the tube may comprise moistening channels (4) for moistening the plant roots, drain gutters (5) for draining water surplus and a channel (6) for supplying CO₂ and/or another gaseous medium to the plant roots. Additionally, the tube may comprise a permeable separation wall (7) between a plant root area (8) and the drain gutters (5) and/or the channel (6) for supplying CO₂ to the plant roots. The tube, including any comprised channels, may be manufactured of a thin-walled, foil-like plastic, e.g. by extrusion. An anti-biofouling layer and/or treatment may be provided at the tube's interior surface.

The present invention presents a novel growth system for plants.

Aims of this novel growth system according to the present invention comprise:
low investments;
no substrate needed like e.g. soil or rockwool;
more plants per m²;
considerable less water consumption;
less pesticides.

To that end a growth system according to the invention preferably comprises a tube which is arranged to be inserted by plant cartridges each being arranged to comprise at least one plant and enabling the plant roots to extend into the interior of the tube. Moreover it is preferred that the tube comprises at least one moistening channel for moistening the plant roots and, moreover, that the tube comprises at least one drain gutter or channel for draining water surplus.

After germination, the plant roots will extend into the interior of the tube, while the stalks, leafs, flowers and/or fruits extends above the tube. The tube serves for feeding nutriments, water and—when needed—additions to a row plants and for draining away all surpluses. Due to the closed character of the tubes, the plant roots are protected against external pestiferous influences, e.g. caused by bacteria, germs, fungi etc.

It may be preferred that the tube comprises at least one channel for supplying CO2 and/or another gaseous medium to the plant roots. Especially in the first phase of the plant growth the CO₂ pressure may inflate the tube—which preferably may be manufactured of a thin-walled, foil-like plastic—in order to maintain the desired tube form. When the plants grow, their roots may fill a substantial part of the inner volume of the tube.

To prevent that the plant roots, by their growth, may hinder the supply of CO₂ and/or the drain of water, it may be preferred that the tube comprises a permeable separation wall between a plant root area—which may be filled by the plants roots—and the drain gutter(s) or channel(s) for draining water surplus and/or the channel(s) for supplying CO₂ to the plant root.

The tube, including any comprised channels etc., preferably is manufactured by extrusion. To prevent deposition of bacteria etc. in a water film on the tube's inner surface, that inner surface preferably may be provided with an anti-biofouling layer and/or undergo an anti-biofouling treatment at its interior surface.

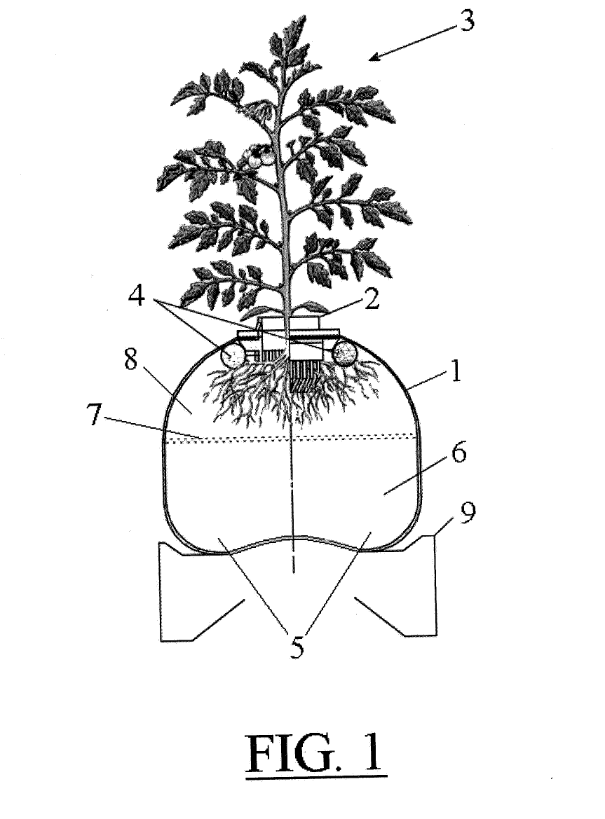

FIG. 1 shows a cross-sectional view a preferred embodiment of the growth system according to the invention.

In the embodiment of the novel growth system for plants as shown in FIG. 1 a tube 1 is arranged to be inserted by plant cartridges 2 each comprising at least one plant—in first instance having the form of seed or seedling—and enabling the plant roots—during the growth—to extend into the interior of the tube. The tube 1 comprises moistening channels 4 for moistening the plant roots by water or mist. To that end the moistening channels 4 will have to be made permeable during the manufacturing process, e.g. by puncturing the walls of channels 4. The tube 1, moreover, comprises at least one drain gutter 5 for draining any liquid (water) surplus.

The tube also comprises a channel 6 for supplying CO2 and/or another gaseous medium to the plant roots. To prevent that de channel 6 and/or the gutters 5 grow dense by the plant roots, thus hindering their function, a permeable—e.g. punctured—separation wall 7 between a plant root area (channel) 8 and the drain gutters 5 and/or the channel 6 for supplying CO2 and/or another gaseous medium to the plant roots.

As can easily be understood, the tube, including any comprised channels is able to be manufactured by extrusion. Moreover, the tube, including its channels may be manufactured of a thin-walled, foil-like plastic, e.g. polyethylene.

If desired or needed, to prevent deposition of bacteria etc. in a water film on the tube's inner surface, that inner surface may—preferably during the manufacturing process—be provided with an anti-biofouling layer and/or undergo an anti-biofouling treatment at the interior surface of the channels 6 and 8.

The tube 1 may be carried by a (e.g. metal) support rail 9, which also provides, by its spherical shape, for the two separate drain gutters 5.

The plant root channel 8 may be subdivided by separation walls between the locations of the plant cartridges (20) and thus between the roots of the individual plants. The aim of those walls—which may be made from the same foil as the remaining of the tube 1 and may be sealed together with the tube wall—is to separate the roots and thus to prevent the spread of plant diseases. Moreover, the tube 1 attains specific regions where flexing of the tube becomes possible, thus facilitating the tube 1 to be installed in a curve.

1. A growth system for plants, comprising
a tube which is arranged to be inserted by plant cartridges each comprising at least one plant and enabling roots of the plant to extend into the interior of the tube;
the tube comprising at least one moistening channel for moistening the plant roots;
the tube comprising at least one drain or channel for draining water surplus.

2. The growth system according to claim 1, the tube further comprising at least one channel for supplying CO₂ and/or another gaseous medium to the plant roots.

3. The growth system according to claim 1, the tube further comprising a permeable separation wall between a plant root area and at least one of said at least one drain or channel for draining water surplus and said at least one channel for supplying CO₂ to the plant root.

4. The growth system according to claim 1, the tube, including any comprised channels, being manufactured by extrusion.

5. The growth system according to claim 1, the tube, including any comprised channels, being manufactured of a thin-walled, foil-like plastic.

6. The growth system according to claim 1, comprising at least one of an anti-biofouling layer and anti-biofouling treatment at its interior surface.

7. The growth system according to claim 1, said plant root area of the tube being subdivided by separation walls between the locations of the individual plant cartridges.

8. The growth system according to claim 3, the tube further comprising a permeable separation wall between a plant root area and at least one of said at least one drain gutter or channel for draining water surplus and said at least one channel for supplying CO₂ to the plant root.

9. The growth system according to claim 3, the tube, including any comprised channels, being manufactured by extrusion.

10. The growth system according to claim 9, the tube, including any comprised channels, being manufactured of a thin-walled, foil-like plastic.

11. The growth system according to claim 3, comprising at least one of an anti-biofouling layer and an anti-biofouling treatment at its interior surface.

12. The growth system according to claim 3, said plant root area of the tube being subdivided by separation walls between the locations of the individual plant cartridges.
